(19) United States
(12) Patent Application Publication
(10) Pub. No.: US 2025/0135438 A1
(43) Pub. Date: May 1, 2025

(54) ZIRCONIA SUPPORT FOR HETEROGENEOUS CATALYSTS

(71) Applicants: Johnson Matthey Public Limited Company, London (GB); Virent, Inc., Madison, WI (US)

(72) Inventors: Brian Blank, Madison, WI (US); Ralf Dotzel, Redwitz and der Rodach (DE); Dana Hatch, Madison, WI (US); Philip John Hughes, Billingham (GB); Martin Max Langbein, Redwitz and der Rodach (DE); Paul Andrew McGuire, Billingham (GB); Hubert Schedel, Redwitz and der Rodach (DE); Stuart Michael Small, Billingham (GB); Edgar Steenwinkel, Madison, WI (US); Charalambos Thoma, Billingham (GB)

(21) Appl. No.: 18/926,093

(22) Filed: Oct. 24, 2024

Related U.S. Application Data
(60) Provisional application No. 63/593,752, filed on Oct. 27, 2023.

(30) Foreign Application Priority Data
Dec. 6, 2023 (GB) 2318630.7

(51) Int. Cl. B01J 21/06; B01J 35/50; B01J 35/61; B01J 35/63; B01J 37/08; C01G 25/02

(52) U.S. Cl. CPC B01J 21/066; B01J 35/50; B01J 35/613; B01J 35/615; B01J 35/633; B01J 37/08; C01G 25/02; C01P 2004/30; C01P 2006/12; C01P 2006/14; C01P 2006/21; C01P 2006/80

(57) ABSTRACT

The specification describes a zirconia support comprising ≥95 wt % ZrO₂, wherein: the support has a crush strength of 20 to 140 N; the support has a total pore volume of 0.10 to 0.40 mL/g when measured by N₂ physisorption; the support has an acid site density of 15 to 30 μL_{NH3}/m²; and the support has a basic site density of 0.006 to 0.015 wt %/m² as measured by the MBOH test. Also described is a method for producing a zirconia supporting starting from zirconia or zirconium hydroxide as raw materials.

### FIELD OF THE INVENTION

The present invention relates to the preparation of zirconia supports, a method of manufacturing the zirconia supports, and supported catalysts made therefrom.

### BACKGROUND

Zirconia is a material with good stability and moderate acidity making it an interesting catalyst carrier. Zirconia may be used to produce shaped bodies such as spheres, granules or cylinders. Shaped zirconia bodies formed by extrusion often have low crush strength and various approaches have been described to improve the crush strength.

WO2004/065002A1 (Shell) describes a process for preparing calcined zirconia extrudates comprising the steps of: preparing a shapable dough comprising particulate zirconia having a total solids content of 50 to 85% by weight, extruding the shapeable dough to form a zirconia extrudate, and drying and calcining the zirconia extrudate. The particular zirconia comprises no more than 15% by weight of zirconia which is other than monoclinic zirconia.

WO2010/101636A2 (Sud-Chemie Inc) describes the incorporation of a polyacid/promoter material selected from the group consisting of a polyacid, a polyacid comprising the oxide or acid form of chromium, molybdenum or tungsten. A typical molar ratio of zirconium:promoter is between 2:1 and 20:1.

WO2015/167978A1 (Clariant) describes a material comprising 50 to 99 wt % zirconium oxide and 1 to 50 wt % of a metal oxide (on a metallic basis) selected from nickel oxide, copper oxide, cobalt oxide, iron oxide and zinc oxide. The presence of the metal oxide is thought to stabilize the zirconium oxide from undergoing the undesirable phase transition from the tetragonal or amorphous phase to the less desirable monoclinic phase.

U.S. Pat. No. 5,269,990A describes shaped zirconia particles which are prepared by mixing zirconia powder and an aqueous colloidal zirconia solution or an aqueous acid solution so ad to obtain a shapable mixture containing 4-40 wt % water, shaping the mixture, and heating the shaped particles at a temperature in excess of about 90° C.

US2002/0123424A1 and US20023/130117A1 describe a process for making a zirconia catalyst by preparing a paste by mixing zirconium hydroxide with various additives, then forming, drying and calcining the particles at a temperature of at least 400° C.

US2011/0301021A1 describes a polyacid-promoted zirconia catalyst or catalyst support, which can be made by combining a zirconium compound with a polyacid/promoter material, which may be Cr, Mo or W, phosphoric acids, sulfuric acids and polyorganic acids.

Zirconia supports have been used commercially in hydrodeoxygenation (HDO) catalysts, as described in U.S. Pat. No. 9,314,778B2 (Virent, Inc) and the references cited therein. The HDO reaction is a key reaction in Virent Inc's BioForming™ technology for the conversion of biomass to fuels. In order to further promote the take-up of this technology, there is a need for zirconia supports which are simple and inexpensive to manufacture, and ideally which improve the performance of an HDO catalyst comprising Pd, Mo and Sn on a zirconia support.

The present inventors sought to provide alternative zirconia supports which are (i) simple and inexpensive to manufacture; and (ii) which perform well when used as the support for an HDO catalyst.

### SUMMARY OF THE INVENTION

Initial trials by the present inventors sought to produce a zirconia shaped body with crush strength comparable or better than commercially available zirconia supports. The shaped bodies were also converted into hydrodeoxygenation (HDO) catalysts by impregnation with palladium, tin and molybdenum salts, as will be more fully described in the examples. Crush strength could be increased by increasing the calcination temperature, but it was found that increasing the calcination temperature eventually led to a negative impact on performance of the support in the HDO reaction due to changes in the concentration of acid and basic sites. Ultimately, it was found that in order to achieve good performance in the HDO reaction it was necessary to carefully control the concentration of acid and basic sites within a certain range. The concentration of acid and basic sites is impacted by several factors including: choice of raw material; additives used in the process; and calcination conditions.

In a first aspect the invention relates to a zirconia support comprising ≥95 wt % ZrO₂, wherein:
the support has a crush strength of 20 to 140 N;
the support has a total pore volume of 0.10 to 0.40 mL/g when measured by N₂ physisorption;
the support has an acid site density of 15 to 30 μL_{NH3}/m²; and
the support has a basic site density of 0.006 to 0.015 wt %/m² as measured by the MBOH test.

The zirconia support according to the first aspect has a good balance between crush strength and performance in the HDO reaction.

In a second aspect the invention relates to a method of manufacturing a zirconia support, comprising the steps of:
(i) combining a raw material selected from ZrO₂ or Zr(OH)₄ with a lubricant;
(ii) mixing the product of step (i) with an additive selected from an acid, a base or a zirconium salt, and extruding the mixture to form a shaped body; or tabletting the product of step (i) to form a shaped body;
(iii) drying the shaped body; and
(iv) calcining the shaped body.

The zirconia support is preferably as defined in the first aspect.

### DESCRIPTION OF THE FIGURES

FIG. 1 shows the relationship between basic sites/BET surface area and activity.

FIG. 2 shows the relationship between acidic sites/BET surface area and activity.

FIG. 3 shows how the average diameter of a trilobe is measured; the trilobe shown has an average diameter of 1.4 mm.

### DETAILED DESCRIPTION

Any sub-headings are included for convenience only and are not to be construed as limiting the disclosure in any way.

### Support

The support comprises ≥95 wt % ZrO₂ based on the total weight of the support. The amount of metal oxides other than ZrO₂ is ≤5 wt % (support comprises ≥95 wt % ZrO₂), preferably ≤4 wt % (support comprises ≥96 wt % ZrO₂), ≤3 wt % (support comprises ≥97 wt % ZrO₂), ≤2 wt % (support comprises ≥98 wt % ZrO₂), ≤1 wt % (support comprises ≥99 wt % ZrO₂).

The support has a total pore volume of 0.10 to 0.40 mL/g when measured by the procedure reported in the examples. A typical total pore volume is 0.12 to 0.30 mL/g.

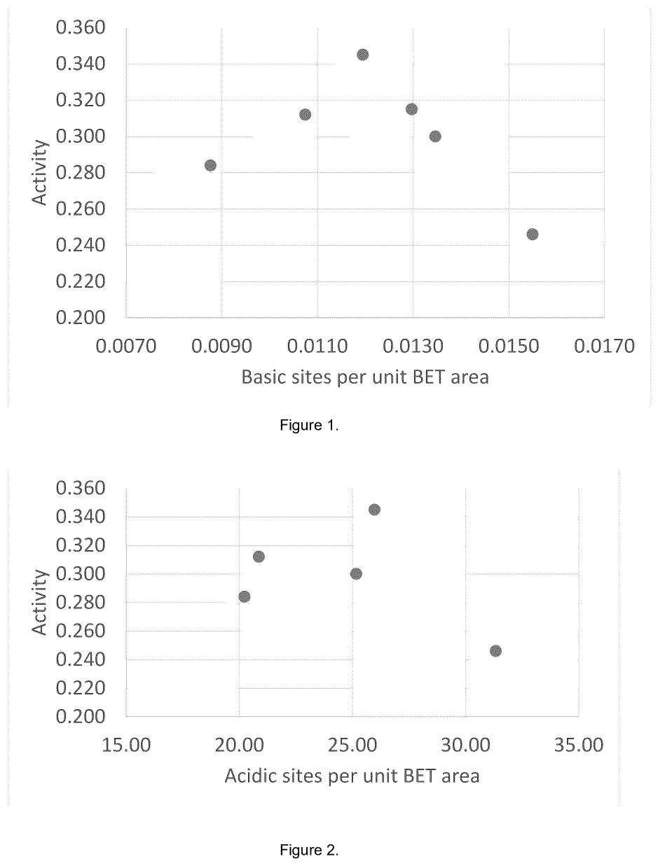

The support has a basic site density of 0.006 to 0.015 wt %/m² as measured by the MBOH test reported in the examples, preferably of 0.0075 to 0.014 wt %/m², more preferably of 0.010 to 0.014 wt %/m², more preferably of 0.010 to 0.013 wt %/m². Supports having a basic site density within these ranges have optimal performance as HDO catalyst when impregnated with Pd, Mo and Sn, as is shown in FIG. 1.

The support has an acid site density of 15 to 30 μL_{NH3}/m² when measured by the procedure reported in the examples, preferably 19 to 28 μL_{NH3}/m². Supports having an acid site density within these ranges have optimal performance as HDO catalyst when impregnated with Pd, Mo and Sn, as is shown in FIG. 2.

The support has a crush strength of 20 to 140 N when measured by the procedure reported in the examples. A typical crush strength is 20 to 80 N, such as 20 to 60 N.

In one embodiment the support is a tungstated catalyst comprising ≥95 wt % ZrO₂ and ≤5 wt % WO₃. These supports may be used for preparing a HDO catalyst, as described in U.S. Pat. No. 9,314,778 B2.

In one embodiment the support is essentially free of tungsten (W), for example comprising ≤0.1 wt % W, such as ≤0.05 wt % W.

In one embodiment the support has a spherical cross-section.

In a preferred embodiment the support has a trilobe or tetralobe cross-section. A particularly preferred support has a trilobe cross-section with an average diameter of 1.0 to 4.0 mm, such as 1.0 to 2.0 mm.

### Manufacture of Support

The inventors investigated the use of zirconia (ZrO₂) or Zr(OH)₄ as a raw material in step (i). It was possible to produce supports having good radial crush strength regardless of which raw material was used.

Any suitable lubricant may be used in step (i). Preferred lubricants include microcrystalline cellulose, hydroxymethyl cellulose or a metal stearate. Typically the lubricant and either ZrO₂ or Zr(OH)₄ are dry blended in step (i).

Step (ii) involves the formation of an extrudate or tablet. In the case of extrusion, an additive is first added to the product mixture from step (i). The additive is typically provided as an aqueous solution. A role of the additive is to act as a binder for the ZrO₂ or Zr(OH)₄ raw material. Without wishing to be bound by any theory, it is thought that the additive may cause cross linking (in the case of zirconium acetate or zirconium nitrate) or peptising (in the case of nitric acid or ammonium hydroxide).

The temperature to which the support is calcined in step (iv) has an impact on the properties of the support. As the calcination temperature is increased there is a decrease in the number of acid sites (measured in terms of μL_{NH3}/gₛᵤₚₚₒᵣₜ), the number of basic sites (measured in terms of wt %/gₛᵤₚₚₒᵣₜ) and the surface area. Whilst the number of acid and basic sites decreases with increasing calcination temperature, the concentration of acid and basic sites, measured in terms of μL_{NH3}/m² and wt %/m² respectively, may increase if the surface area reduces at a faster rate than the number of acid and basic sites reduces. As well as acting as a binder for the ZrO₂ or Zr(OH)₄ raw material, the inclusion of an additive can be used to tune the acid and basic site density. The inventors have found that the choice of additive affects the acid/base properties of the resulting zirconia support, which can impact on the suitability of the support for the catalyst in question.

In some embodiments the additive is ammonia or an acid, such as nitric acid. In both cases, it was possible to produce a support which had acceptable strength and performed well as HDO catalysts. While the addition of ammonia or an acid as an additive produced a support with good strength and good to excellent performance as HDO catalysts, the use of ammonia or an acid may not be compatible with manufacturing equipment. Therefore, in some embodiments a zirconium salt is used. Preferred zirconium salts include zirconium nitrate, zirconium acetate and ammonium zirconium carbonate. Surprisingly, the use of a zirconium salt as the additive leads to a support with higher strength than could be achieved with ammonia or nitric acid. Therefore, the use of a zirconium salt may be preferred when a high strength zirconia support is desired. The use of zirconium salts, particularly zirconium acetate, is also typically more compatible with manufacturing equipment than either ammonia or acids and they may be preferred for this reason.

In the case of tabletting, it is not necessary to add an additive to the product of step (i) before tabletting.

Step (ii) also involves the formation of a shaped body by extrusion (“extrudates”) or by tabletting (“tablets”). In each case, the cross-section of the shaped body may be spherical (e.g. cylinders) or may be shaped. Preferred shaped bodies have a trilobe or tetralobe cross-section, as this provides a catalyst which has a high geometric surface area which is beneficial for activity. Extrusion and tabletting conditions will be well known to those skilled in the art.

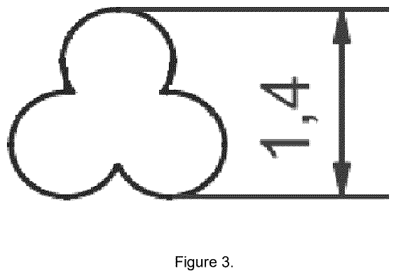

Typically a shaped body formed by extrusion (“extrudate”) will have an elongated shape. The cross-section of the extrudate may be spherical (i.e. cylindrical extrudates) or may be shaped. Multilobe shapes such as trilobes or tetralobes are preferred, particularly trilobes, because these shapes have a relatively high surface area with low pressure drop. A particularly suitable shape is a trilobe with an average diameter of 1.0 to 4.0 mm, such as 1.0 to 2.0 mm. FIG. 3 shows how the average diameter of a trilobe is measured.

Step (iii) involves drying the shaped body to remove excess water. Drying conditions will readily be determined by those skilled in the art.

Step (iv) involves calcining the product of step (iii). As was explained previously, increasing calcination temperature is associated with a decrease in the number of acid sites, basic sites and surface area. When the support is to be used for an HDO catalyst it is preferred that the calcination temperature in step (iv) is between 300-800° C., such as 300-500° C. or 350-450° C. A calcination time of 2-6 hours is typically sufficient although this may vary depending on scale.

### EXAMPLES

### Raw Materials

SGN SZ31164 are commercial zirconia extrudates (1.2 mm diameter) from NorPro Saint Gobain

ZOH-85 is a commercial Zr(OH)₄ from Zircomet

Z-3186 and is a commercial ZrO₂ from Daiichi Kigenso Kagaku Kogyo Co. Ltd.

RC-100 is a commercial ZrO₂ from Daiichi Kigenso Kagaku Kogyo Co. Ltd.

XZO 631/01 is a commercial Zr(OH)₄ from MEL Chemicals

### General Procedure for Manufacturing Supports

The raw material (ZrO₂ or Zr(OH)₄) was dry mixed with a lubricant (either microcrystalline cellulose, hydroxymethyl cellulose or magnesium stearate). In the case of extruded catalysts, a solution of additive (either 5% ammonia, 5% nitric acid, zirconium nitrate solution or zirconium acetate solution) was added and the mixture was either extruded into trilobes with a 1.3 mm average diameter or into cylinders with a 1.6 mm diameter. In the case of pelleted catalysts, the mixture of raw material and lubricant was pelleted into tablets with a 3.3 mm diameter. The materials were dried (120° C.) and then calcined under the conditions specified.

### Procedure for Measuring Crush Strength

Radial crush strength was measured using an Engineering Systems CT6 instrument. A crush speed of 22 mm/min was used with a 50 kg load cell. 20 individual particulates were analysed and the average value calculated.

### Procedure for Measuring Total Pore Volume and BET Surface Area

Surface area was measured using a Micromeritics 2420 ASAP physisorption analyser by application of the BET method in accordance with ASTM Method D 3663-03; Standard Test for Surface Area. Nitrogen was used as the adsorbate and the measurements carried out at liquid nitrogen temperature. The cross-sectional area of a nitrogen molecule was taken as 16.2 Å². Samples were outgassed prior to analysis by purging with dry nitrogen gas for a minimum of 1 hour at an optimal temperature. Five relative pressure/volume data pairs were obtained over the relative pressure region of 0.05 to 0.20 P/Pₒ inclusive. The equilibration time for each point was 10 seconds. Surface areas are reported based on the weight of the sample post outgassing. Full adsorption/desorption isotherms were measured over the relative pressure range of 0.05 to 0.995 and back to 0.05. The total pore volume was determined at the last point on the adsorption isotherm (0.995 P/Pₒ).

### Procedure for Measuring Acid Site Density

The particulate was ground to a powder and charged to a Micromeritics AutoChem 2950HP thermal analyser. A 40 mL/min flow of helium was passed over the particulate at atmospheric pressure while heating to 400° C. at a rate of 20° C./min. A temperature of 400° C. was maintained for 10 minutes before cooling to 120° C. Once at 120° C. a 40 mL/min flow of helium and a 40 mL/min flow of 5% v/v ammonia in helium was passed over the particulate for 30 minutes. The physisorbed ammonia was purged using a 40 mL/min flow of helium for 30 minutes. The particulate temperature was increased to 700° C. at a rate of 5° C./min and held for 30 minutes, during this time a TCD detector was used to monitor the desorption of ammonia from the particulate. The total amount of ammonia desorbed was calculated by integrating the desorption profile which had been calibrated using known quantities of ammonia in helium. This value was then normalised by the samples BET surface area (measured according to the BET surface area procedure) to obtain the acid site density in μL_{NH3}/m².

### Procedure for Measuring Basic Site Density

This procedure is based on the procedure described in the articles “Evaluation of Surface Acid-Basic Properties of Inorganic-Based Solids by Model Catalytic Alcohol Reaction Networks” (Catalyst Reviews, 48:315-362, 2006) and “Synthesis and Characterization of ZrO₂ as Acid-Basic Catalysts: Reactivity of 2-Methyl-3-butyn-2-ol” (Journal of Catalysis 183, 240-250 (1999)).

6 g of particulate was charged to a static 45 mL autoclave along with 15 mL of 2-Methyl-3-butyn-2-ol (MBOH) and a single droplet of water. This was placed in a furnace/oven and subjected to a temperature of 200° C. for 18 hours before cooling to room temperature. The reaction liquid is analysed by gas chromatography for 2-Methyl-1-buten-3-yne (Mbyne), Mesityl oxide (MO), 2-Methyl-3-butyn-2-ol (MBOH), 3-Methyl-2-butenal (Prenal), 3-Hydroxy-3-methyl-2-butanone (HMB), 4-Hydroxy-4-Hydroxy-4-methyl-2-pentanone (DAA) using external standards. The quantity of Acetone and 4-Hydroxy-4-Hydroxy-4-methyl-2-pentanone (DAA) is added and divided by the particulate BET surface area in 6 g to obtain the basic site density in wt. %_{basic products}/m².

### General Co-Impregnation Procedure for Manufacturing HDO Catalysts

The supports S1 and S3 to S7 described in Table 1 were converted into HDO catalysts C1 and C3 to C7 by the following procedure. Zirconia extrudates were loaded into a tumbler. An impregnation solution was prepared by dissolving ammonium molybdate, palladium nitrate solution, tin oxalate and citric acid in deionized water up to the absorption volume of the extrudates. The impregnation solution was added over approximately 2 minutes to the tumbler mixer with gentle rotation (approximately 2 rpm) and the mixture was allowed to tumble for a further 15 mins (approximately 2 rpm). The impregnated tablets were transferred to an oven and dried overnight at 105° C. and then calcined in air at 400° C., with a ramp rate of 2° C./min and held for 4 hours. The resulting catalysts contained 1 wt % Pd, 2 wt % Mo and 0.25 wt % Sn, with the exception of S2 which contained 1 wt % Pd, 1 wt % Mo and 0.25 wt % Sn.

### General Sequential Impregnation Procedure for Manufacturing HDO Catalysts

The support S2 described in Table 1 was converted into HDO catalyst S2 by the following procedure. Zirconia extrudates were loaded into a tumbler. An impregnation solution was prepared by dissolving ammonium molybdate, tin oxalate and citric acid in deionized water up to the absorption volume of the extrudates. The impregnation solution was added over approximately 2 minutes to the tumbler mixer with gentle rotation (approximately 2 rpm) and the mixture was allowed to tumble for a further 15 mins (approximately 2 rpm). The impregnated extrudates were transferred to an oven and dried overnight at 105° C. and then calcined in air at 400° C., with a ramp rate of 2° C./min and held for 4 hours. The catalyst intermediate was then removed from the oven and loaded into a tumbler. An impregnation solution of palladium nitrate was made up to the absorption volume with deionized water. The impregnation solution was added over approximately 2 minutes to the tumbler mixer with gentle rotation (approximately 2 rpm) and the mixture was allowed to tumble for a further 15 mins (approximately 2 rpm). The impregnated extrudates were transferred to an oven and dried overnight at 105° C. and then calcined in air at 400° C., with a ramp rate of 2° C./min and held for 4 hours.

TABLE 1

| | S1¹ | S2¹ | S3¹ | S4 | S5 | S6 | S7 |
|---|---|---|---|---|---|---|---|
| Raw Material | SGN | ZOH-85 | XZO | Z-3186 | RC-100 | Z-3186 | Z-3186 |
| | SZ31164 | Zr(OH)₄ | 631/01 | ZrO₂ | ZrO₂ | ZrO₂ | ZrO₂ |
| | | | Zr(OH)₄ | | | | |
| Forming | Extrusion | Tabletting | Extrusion | Extrusion | Extrusion | Extrusion | Extrusion |
| process | | | | | | | |
| Shape | Cylinders | Tablet | Trilobes | Cylinders | Cylinders | Trilobes | Trilobes |
| (diameter) | (1.2 mm) | (3.3 mm) | (1.3 mm) | (1.6 mm) | (1.6 mm) | (1.3 mm) | (1.3 mm) |
| Additive | — | — | 10% nitric | 5% nitric | 5% | zirconium | zirconium |
| | | | acid | acid | ammonia | nitrate | acetate |
| Calcination | —² | 300 | 400 | 400 | 400 | 400 | 400 |
| temperature | | | | | | | |
| (° C.) | | | | | | | |
| Radial crush | 17.7 | 57 | 40.2 | 20.6 | 23.5 | 46.1 | 39.2 |
| strength (N) | | | | | | | |
| Pore volume | 0.28 | 0.14 | 0.18 | 0.23 | 0.25 | 0.18 | 0.14 |
| (mL/g) | | | | | | | |
| BET surface | 97.4 | 178.8 | 29.9 | 84.6 | 95.3 | 76.9 | 74.3 |
| area | | | | | | | |
| (m²/gₛᵤₚₚₒᵣₜ) | | | | | | | |
| Acid site | 20.23 | 13.87 | 31.34 | 25.16 | 25.98 | — | 20.86 |
| density | | | | | | | |
| (μL_{NH3}/m²) | | | | | | | |
| Basic site | 0.0088 | 0.0054 | 0.0155 | 0.0135 | 0.0119 | 0.013 | 0.0107 |
| density | | | | | | | |
| (wt %/m² from | | | | | | | |
| MBOH test) | | | | | | | |

| | C1 | C2 | C3 | C4 | C5 | C6 | C7 |
|---|---|---|---|---|---|---|---|
| Impregnation | co- | sequential | co- | co- | co- | co- | co- |
| route | impreg | | impreg | impreg | impreg | impreg | impreg |
| Relative | 1.86 | 1.00 | 1.61 | 1.96 | 2.25 | 2.06 | 2.04 |
| activity (H₂ | | | | | | | |
| consumption | | | | | | | |
| @ 242° C.) | | | | | | | |

¹Not claimed
²It is not known what temperature these commercial extrudates are calcined at.

Analysis of the data in Table 1 indicated the following:
Good crush strength could be achieved when using either Zr(OH)₄ or ZrO₂ as raw material;
The addition of zirconium nitrate (S6) or zirconium acetate (S7) is beneficial for strength, particularly zirconium nitrate;

FIG. 1 shows the relationship between basic sites/BET area and activity. The activity peaks for C5 which is based on support S5 having a basic site density of 0.0119 wt %/m² from MBOH test.

FIG. 2 shows the relationship between acidic sites/BET area and activity. The relationship is less pronounced than for basic site density.

### Impact of Calcination Temperature

The impact of calcination temperature on various properties including the crush strength, BET surface area, the number of acid and basic sites and the concentration of acid and basic sites was studied using a variety of supports and different additives. Some selected results are included in Tables 2, 3 and 4.

Table 2 shows the impact of calcination temperature on the crush strength, acid site density and basic site density of supports prepared from RC-100 (ZrO₂). As the calcination temperature increased the crush strength, basicity and BET surface area decreased. The acid site density and basic site density both increased.

TABLE 2

| | S8 | S9 |
|---|---|---|
| Raw Material | RC-100 | RC-100 |
| | ZrO₂ | ZrO₂ |
| Forming process | Extrusion | Extrusion |
| Shape | Trilobe | Trilobe |
| (diameter) | (1.3 mm) | (1.3 mm) |
| Additive | Ammonium | Ammonium |
| | zirconium | zirconium |
| | carbonate | carbonate |
| Calcination | 400 | 500 |
| temperature | | |
| (°C.) | | |
| Radial crush strength | 54.6 | 79.9 |
| (N) | | |
| Surface area | 91.3 | 63.4 |
| (m²/g) | | |
| Acidity | 2.49 | 2.50 |
| (mL_{NH3}/g) | | |
| Acid site density | 27.27 | 39.43 |
| (μL_{NH3}/m²) | | |
| Basicity | 0.97 | 0.73 |
| (wt %/g) | | |
| Basic site density | 0.0107 | 0.0115 |
| (wt %/m²) | | |

Table 3 shows the impact of calcination temperature on the pore volume and BET surface area of supports prepared from XZO 631/01 Zr(OH)₄. As the calcination temperature increased the BET surface area and the pore volume decreased.

TABLE 3

| | S11 | S12 |
|---|---|---|
| Raw Material | XZO 631/01 | XZO 631/01 |
| | Zr(OH)₄ | Zr(OH)₄ |
| Forming process | Tabletting | Tabletting |
| Shape | Tablet | Tablet |
| (diameter) | (3.3 mm) | (3.3 mm) |
| Additive | — | — |
| Calcination | 400 | 500 |
| temperature | | |
| (° C.) | | |
| Pore volume | 0.37 | 0.19 |
| (mL/g) | | |
| BET surface area | 125 | 38.2 |
| (m²/gₛᵤₚₚₒᵣₜ) | | |

Table 4 shows the impact of the additive on acid site density of supports prepared from XZO 631/01 Zr(OH)₄ under identical calcination conditions. The acid site density could be tuned by controlling the strength of the nitric acid used as the additive.

TABLE 4

| | | |
|---|---|---|
| Raw Material | XZO | XZO |
| | 631/01 | 631/01 |
| | Zr(OH)₄ | Zr(OH)₄ |
| Forming process | Extrusion | Extrusion |
| Shape | Trilobe | Trilobe |
| (diameter) | (1.3 mm) | (1.3 mm) |
| Additive | 10% nitric acid | 20% nitric acid |
| Calcination temperature | 600 | 600 |
| (° C.) | | |
| Radial crush strength | 41.3 | 61.4 |
| (N) | | |
| Pore volume | 0.29 | 0.19 |
| (mL/g) | | |
| BET surface area | 29.9 | 31.7 |
| (m²/gₛᵤₚₚₒᵣₜ) | | |
| Acid site density | 31.34 | 24.92 |
| (μL_{NH3}/m²) | | |

The results in Tables 2, 3 and 4 illustrate the following. Firstly, there is a positive correlation between calcination temperature and crush strength (Table 2). Secondly, there is an inverse correlation between calcination temperature and the number of acid sites and number of basic sites (Table 2). Thirdly, there is an inverse correlation between calcination temperature and both pore volume and BET surface area (Tables 2, 3). For a given raw material the properties of the resulting support depend on the calcination temperature. The crush strength can be increased by choosing a suitably high calcination temperature, but this will quickly produce a material which as undesirably high concentration of acid sites. It is possible to counterbalance this by choosing an appropriate additive (Table 4).

1. A zirconia support comprising ≥95 wt % ZrO₂, wherein:
the support has a crush strength of 20 to 140 N;
the support has a total pore volume of 0.10 to 0.40 mL/g when measured by N₂ physisorption;
the support has an acid site density of 15 to 30 μL_{NH3}/m²; and
the support has a basic site density of 0.006 to 0.015 wt %/m² as measured by the MBOH test.

2. A support as claimed in claim 1, wherein the support comprises ≥98 wt % ZrO₂.

3. A support as claimed in claim 1, wherein the support comprises ≥99 wt % ZrO₂.

4. A support as claimed in any of claims 1 to 3, wherein the support has a crush strength of 20 to 80 N.

5. A support as claimed in any of claims 1 to 4, wherein the support has an acid site density of 19 to 28 μL_{NH3}/m².

6. A support as claimed in any of claims 1 to 5, wherein the support has a basic site density of 0.0075 to 0.014 wt %/m².

7. A support as claimed in any of claims 1 to 6, wherein the support is in the form of a trilobe.

8. A support as claimed in claim 7, wherein the support is in the form of a trilobe with an average diameter of 1.0 to 4.0 mm.

9. A support as claimed in any of claims 1 to 8, wherein the support has:
a crush strength of 20 to 80 N;
a total pore volume of 0.10 to 0.40 mL/g;
an acid site density of 19 to 28 μL_{NH3}/m²; and
a basic site density of 0.0075 to 0.014 wt %/m².

10. A method of manufacturing a zirconia support, comprising the steps of:
(i) combining a raw material selected from ZrO₂ or Zr(OH)₄ with a lubricant;
(ii) mixing the product of step (i) with an additive selected from an acid, a base or a zirconium salt, and extruding the mixture to form a shaped body; or
(iii) tabletting the product of step (i) to form a shaped body;
(iii) drying the shaped body; and
(iv) calcining the shaped body.

11. A method according to claim 10, wherein the raw material used in step (i) is ZrO₂.

12. A method according to claim 10 or claim 11, wherein the lubricant used in step (i) is a microcrystalline cellulose, a hydroxy methyl cellulose, or a metal stearate.

13. A method according to any of claims 10 to 12, wherein the additive is ammonia.

14. A method according to any of claims 10 to 12, wherein the additive is an acid.

15. A method according to claim 14, wherein the additive is nitric acid.

16. A method according to any of claims 10 to 12, wherein the additive is a zirconium salt.

17. A method according to claim 16, wherein the zirconium salt is zirconium nitrate.

18. A method according to claim 16, wherein the zirconium salt is zirconium acetate.

19. A method according to any of claims 10 to 18, wherein in step (ii) the mixture is tableted to form a shaped body.

20. A method according to any of claims 10 to 18, wherein in step (ii) the mixture is extruded to form a shaped body.

21. A method as claimed in any of claims 10 to 20, wherein the shaped body has a spherical cross-section.

22. A method as claimed in any of claims 10 to 20, wherein the shaped body has a trilobe cross-section.

23. A method as claimed in claim 22, wherein the shaped body has a trilobe cross-section with an average diameter of 1.0 to 4.0 mm.

24. A method according to any of claims 10 to 23, wherein during step (iv) the shaped body is calcined at a temperature of 300-500° C.

25. A method according to any of claims 10 to 24, wherein the support is as defined in any of claims 1 to 9.
